(19) United States
(12) Patent Application Publication
(10) Pub. No.: US 2019/0236045 A1
(43) Pub. Date: Aug. 1, 2019

(54) VIRTUAL COMPORT BRIDGE SUPPORTING HOST-TO-HOST USB TRANSMISSION

(71) Applicant: PROLIFIC TECHNOLOGY INC., Taipei (TW)

(72) Inventors: Tien-Wei YU, Hsinchu City (TW); Cheng-Sheng CHAN, Hsinchu City (TW); Chiun-Shiu CHEN, Hsinchu City (TW)

(21) Appl. No.: 16/259,623

(22) Filed: Jan. 28, 2019

(30) Foreign Application Priority Data
Jan. 30, 2018 (TW) 107103300

(51) Int. Cl. G06F 13/40; G06F 13/42; G06F 13/38

(52) U.S. Cl. CPC G06F 13/4027; G06F 13/4282; G06F 2213/3812; G06F 2213/0042; G06F 13/387

(57) ABSTRACT

A USB bridge including a first USB port, a second USB port, a microcontroller, and a host-to-host function circuit is provided. The first USB port is coupled to the first USB host. The second USB port is coupled to the second USB host. The microcontroller is coupled to the first and the second USB ports. The microcontroller communicates with the first and the second USB hosts via the first and the second USB ports, such that the first and the second USB hosts respectively simulate the USB ports of the first and the second USB hosts as virtual comports. The host-to-host function circuit is coupled to the microcontroller and configured to perform a host-to-host transmission function by simulating the USB ports as virtual comports.

This application claims the benefit of Taiwan application Serial No. 107103300, filed Jan. 30, 2018, the subject matter of which is incorporated herein by reference.

### BACKGROUND OF THE INVENTION

### Field of the Invention

The invention relates in general to a virtual comport bridge supporting host-to-host USB transmission.

### Description of the Related Art

The universal asynchronous receiver/transmitter (UART) switches data transmission between serial transmission and parallel transmission. The UART is a simply transmission interface that has been used for long. Since the UART has a simple communication protocol, the software development is made easier.

The universal serial bus (USB) technology support hot plug and can plug and play, therefore the host, for example the desktop and the laptop computers, can be easily connected to any peripheral devices with a USB interface.

In the past, when a mobile device is connected to a host (such as a desktop computer, a notebook computer or a car system) via a USB, the mobile device is regarded as a slave device.

However, as the mobile device (such as a smart phone) is getting more and more popular and the hardware function of the mobile device is getting more and more powerful, the mobile device can change to a host from a slave device, and the host-to-host transmission will become a trend. Therefore, how to satisfy the user's demand of host-to-host transmission has become a prominent task for the industries.

### SUMMARY OF THE INVENTION

According to one embodiment of the present invention, a USB bridge including a first USB port, a second USB port, a microcontroller, and a host-to-host function circuit is provided. The first USB port is coupled to the first USB host. The second USB port is coupled to the second USB host. The microcontroller is coupled to the first and the second USB ports. The microcontroller communicates with the first and the second USB hosts via the first and the second USB ports, such that the first and the second USB hosts respectively simulate the USB ports of the first and the second USB hosts as virtual comports. The host-to-host function circuit is coupled to the microcontroller and configured to perform a host-to-host transmission function by simulating the USB ports as virtual comports.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a system diagram of a USB bridge according to an embodiment of the present disclosure.

FIG. 2 is a functional block diagram of a USB bridge according to an embodiment of the disclosure.

### DETAILED DESCRIPTION OF THE INVENTION

Technical terms are used in the specification with reference to generally-known terminologies used in the technology field. For any terms described or defined in the specification, the descriptions and definitions in the specification shall prevail. Each embodiment of the present disclosure has one or more technical characteristics. Given that each embodiment is implementable, a person ordinarily skilled in the art can selectively implement or combine some or all of the technical characteristics of any embodiment of the present disclosure.

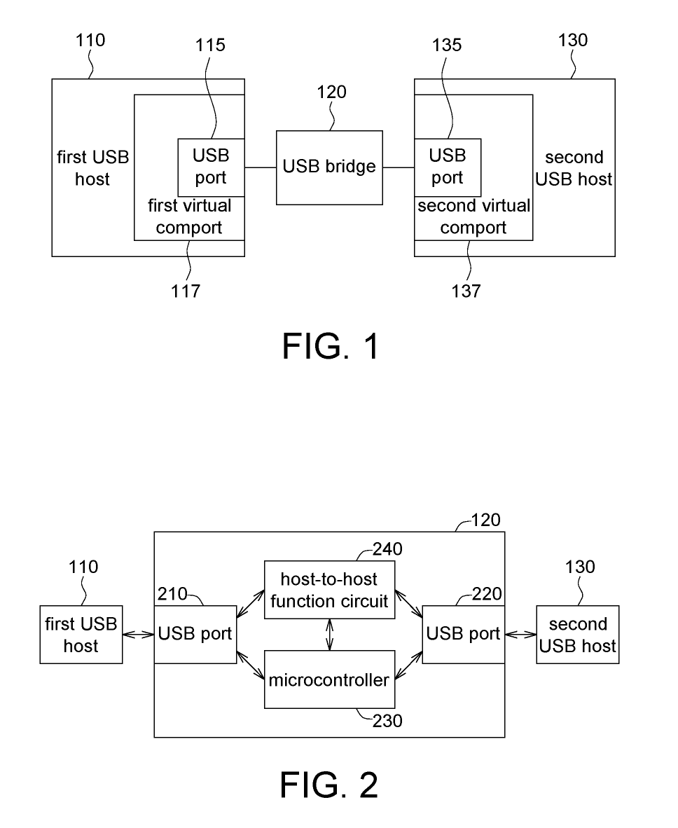

Referring to FIG. 1, a system diagram of a USB bridge according to an embodiment of the present disclosure is shown. As indicated in FIG. 1, the first USB host 110 communicates with the second USB host 130 via the USB bridge 120 having virtual comport function, wherein, the host-to-host communication can be performed between the first USB host 110 and the second USB host 130 via the USB bridge 120 having virtual comport function. The first USB host 110 and the second USB host 130 respectively have USB ports 115 and 135 via which the first USB host 110 and the second USB host 130 can communicate with the USB bridge 120 having virtual comport function. The first USB host 110 simulates the USB port 115 as a corresponding first virtual comport 117; and the second USB host 130 simulates the USB port 135 as a corresponding second virtual comport 137.

Referring to FIG. 2, a functional block diagram of a USB bridge according to an embodiment of the present disclosure is shown. The USB bridge 120 having virtual comport function at least includes USB ports 210 and 220, a microcontroller (MCU) 230 and a host-to-host function circuit 240.

The USB ports 210 and 220 respectively are coupled to the first USB host 110 and the second USB host 130.

The microcontroller 230 is coupled to the USB ports 210, 220, and the host-to-host function circuit 240, and communicates with the first USB host 110 and the second USB host 130 via the USB ports 210 and 220. The microcontroller 230 simulates the USB ports 210 and 220 of the USB bridge 120 (physical USB interfaces) having virtual comport function as virtual comports respectively corresponding to the first virtual comport 117 of the first USB host 110 and the second virtual comport 137 of the second USB host 130. The first USB host 110 can communicate with the second USB host 130 via the first virtual comport 117 of the first USB host 110, the USB bridge 120 and the second virtual comport 137 of the second USB host 130 to complete the communication between the first and the second USB hosts. In the embodiments of the present disclosure, since the application software of the first USB host 110 and the second USB host 130 performs read/write operations on the virtual comport, the software processing become easier. In the embodiments of the present disclosure, the first USB host 110 and the second USB host 130 both have a communication device class (CDC)-abstract control model (ACM) driver built therein. The CDC-ACM driver is a standard driver built in different operating system (OS) platforms (such as the WINDOWS OS, the MAC OS, the LINUX OS, and the Android OS). In the embodiments of the present disclosure, the first USB host 110 and the second USB host 130 both have the standard CDC-ACM driver built therein. Since the standard CDC-ACM driver is compatible with different OS platforms, data transmission between different OS platforms will become easier. That is, suppose the operating systems of the first USB host 110 and the second USB host 130 both have a CDC-ACM driver built therein. When a corresponding device of the USB virtual comport is connected to the first USB host 110 and the second USB host 130, the first USB host 110 and the second USB host 130 both having the CDC-ACM driver built therein can simulate the USB ports 115 and 135 of the first USB host 110 and the second USB host 130 as the first virtual comport 117 and the second virtual comport 137, such that the application software can perform read/write operations on the virtual comports.

The details regarding how the microcontroller 230 simulates the USB ports 210 and 220 (physical USB interfaces) of the USB bridge 120 having virtual comport function as virtual comports are not specified here. Besides, the details regarding how the first USB host 110 communicates with the second USB host 130 via the first virtual comport 117 of the first USB host 110, the USB bridge 120, and the second virtual comport 137 of the second USB host 130 to complete the host communication between two USB hosts are not specified here either. Additionally, the details regarding how the application software of the first USB host 110 and the second USB host 130 perform read/write operations on the virtual comports are not specified here either.

The host-to-host function circuit 240 is coupled to the microcontroller 230 and configured to perform a host-to-host transmission function. The details and the physical architecture of the host-to-host function circuit 240 are not specified here.

The first USB host 110 transmits data to the host-to-host function circuit 240 via the USB port 210. Then, the host-to-host function circuit 240 transmits the data received from the first USB host 110 to the second USB host 130 via the USB port 220. Under some circumstances, data received from the first USB host 110 can be directly transmitted to the second USB host 130 without having to be processed by the microcontroller 230. Under some circumstances, before data received from the first USB host 110 are transmitted to the second USB host 130, data must be processed by the microcontroller 230 beforehand.

Similarly, the second USB host 130 transmits data to the host-to-host function circuit 240 via the USB port 220, and then the host-to-host function circuit 240 transmits the data received from the second USB host 130 to the first USB host 110 via the USB port 220. Under some circumstances, data received from the second USB host 130 can be directly transmitted to the first USB host 110 without having to be processed by the microcontroller 230. Under some circumstances, before data received from the second USB host 130 are transmitted to the first USB host 110, data must be processed by the microcontroller 230 beforehand.

In the above embodiments of the present disclosure, the host-to-host transmission function realized by simulating USB ports as virtual comports is not limited to a single function. The host-to-host transmission function can be realized in multi-functions of a composite device, and is still within the scope of protection of the present disclosure.

In the above embodiments of the present disclosure, when the host-to-host transmission mode is combined with the UART protocol communication interface, which is simple and easy to use, the development of relevant software or system will become much easier. By simulating the USB ports as virtual comports and host-to-host function circuit, data transmission can be performed between two USB hosts, and this is very convenient to software developers.

In the above embodiments of the present disclosure, the first and the second USB host 110 and 130 both support the standard CDC-ACM driver. Therefore, the first and the second USB host 110 and 130 do not need to install additional driver for specific purposes, and this is very convenient to software developers.

In other possible embodiments of the present disclosure, the first and the second USB host 110 and 130 can also support the installation of virtual comport driver developed by a third party (that is, the virtual comport driver developed by the third party can be installed in the first and the second USB host 110 and 130), and this is very convenient to software developers.

According to the generally-known technology, when a physical RS232 UART transceiver circuit is used, the overall transmission speed will be subjected to the transmission speed (about 12 Mb/s) of the physical RS232 UART transceiver circuit, which is far insufficient in today's application. Conversely, in the embodiments of the present disclosure, data transmission is performed via USB interface, therefore the data transmission speed is subjected to the USB data transmission speed, which is much faster than the UART transmission speed.

In the above embodiments of the present disclosure, the use of USB has gained a great popularity, and the specification of UART is simple and easy to use. For many hosts having the USB host function and capable of supporting the UART function, when data are transmitted between multiple hosts having different OS platforms, the UART comport using USB interface can easily meet above requirements.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A USB bridge, comprising:
a first USB port coupled to a first USB host;
a second USB port coupled to a second USB host;
a microcontroller coupled to the first and the second USB ports, wherein the microcontroller communicates with the first and the second USB hosts via the first and the second USB ports, such that the first and the second USB hosts respectively simulate the USB ports of the first and the second USB hosts as virtual comports; and
a host-to-host function circuit coupled to the microcontroller and configured to perform a host-to-host transmission function by simulating the USB ports as virtual comports.

2. The USB bridge according to claim 1, wherein, the first and the second USB hosts both have a communication device class (CDC)-abstract control model (ACM) driver built therein.

3. The USB bridge according to claim 1, wherein, the first and the second USB hosts both have a virtual comport driver developed by a third party installed therein.

4. The USB bridge according to claim 1, wherein, the first USB host and/or the second USB host transmit data to the host-to-host function circuit via the first USB port and/or the second USB port, and, the host-to-host function circuit transmits data received from the first USB host and/or the second USB host to the second USB host and/or the first USB host via the second USB port and/or the first USB port.

5. The USB bridge according to claim 1, wherein, data received from the first USB host and/or the second USB host are transmitted to the second USB host and/or the first USB host without having to be processed by the microcontroller.

6. The USB bridge according to claim 1, wherein, data received from the first USB host and/or the second USB host are transmitted to the second USB host and/or the first USB host after having been processed by the microcontroller.

7. The USB bridge according to claim 1, wherein, the first and the second USB hosts have different operating systems.

8. The USB bridge according to claim 1, wherein, the first and the second USB hosts have the same operating system.
